(19) United States
(12) Patent Application Publication
(10) Pub. No.: US 2024/0028652 A1
(43) Pub. Date: Jan. 25, 2024

(54) Unknown destination in the metaverse

(71) Applicant: Wesley John Boudville, Los Angeles, CA (US)

(72) Inventor: Wesley John Boudville, Los Angeles, CA (US)

(21) Appl. No.: 17/803,466

(22) Filed: Jul. 25, 2022

(51) Int. Cl. G06F 16/951; G06F 16/955; G06T 19/00; G06T 13/40

(52) U.S. Cl. CPC G06F 16/951; G06F 16/955; G06T 19/003; G06T 13/40

(57) ABSTRACT

We address uncertainty about a Metaverse link. If a user clicks and goes to a bad site, where a sex predator might accost her, the immersive nature of the Metaverse can increase trauma to her. Now, before clicking, she asks a search engine to show recent images of the destination. She asks that a spider at the destination meet her when she jumps to it. Or a guardian avatar made by the server can do this. Virtual items can be carried across sites. An avatar can carry another avatar to a site.

### BACKGROUND

The Metaverse is essentially Virtual Reality (VR) combined with a requirement that users use avatars. An avatar is a 3d skin worn by a user, when she goes to a VR site. The site may have in it links to other VR sites, run by the same operator who runs the first site. Or the site might have links to VR sites run by different operators or firms.

A link is put in the first site. A user uses her avatar to click the link, which takes her to a destination site. But given rampant bad behavior documented for the Metaverse, she might be leery of doing so. Existing bad behavior includes sexual harassment, including what some women have characterized as virtual rape.

### BRIEF DESCRIPTION OF THE DRAWINGS

FIG. 1 shows Susan and her avatar in a VR site, near a link to another site.

FIG. 2 shows a search spider entering a VR site.

FIG. 3 shows a guardian appearing near Susan after she jumps to the destination.

FIG. 4 shows Susan staying in source site; uses spider to search destination.

FIG. 4a shows areas occupied by several avatars near each other.

FIG. 5 shows Susan with 2 avatars, used on different sites.

FIG. 5a shows Susan buying an avatar for the destination site.

FIG. 6 shows Susan pushing a cart between sites.

FIG. 7 shows Susan pushing a cart carrying a potted plant to another site.

FIG. 8 shows Susan pushing a cart carrying an avatar to another site.

FIG. 8a shows a box containing a trophy being carried to 2 VR sites.

FIG. 9 shows 2 avatars, each having a clickable link, hugging each other.

FIG. 10 shows an avatar speaking to another and passing a link via speech.

FIG. 11 shows links that point to regions A and B in the destination site.

FIG. 12 shows a region A enclosing a region B.

FIG. 13 shows 3 regions in the destination site.

### DETAILED DESCRIPTION

What we claim as new and desire to secure by letters patent is set forth in the following. This application has the sections:

### 0] Definition of Metaverse;

### 1] Problem;

2] Finding zombies;
3] Patrolling a VR site;
4] Checking a mobile link;
5] Handling avatar Incompatible VR sites;
6] Transporting an item between VR sites;
7] Transmitting a spoken site address by an avatar;
8] Different places in a destination site;
9] Use of a “search engine” and spider;

0] Definition of Metaverse;

As discussed above, we take a practical definition of Metaverse as being VR plus the use of avatars within the VR sites. This sidesteps various hyped-up discussions of what a Metaverse might or can be.

1] Problem;

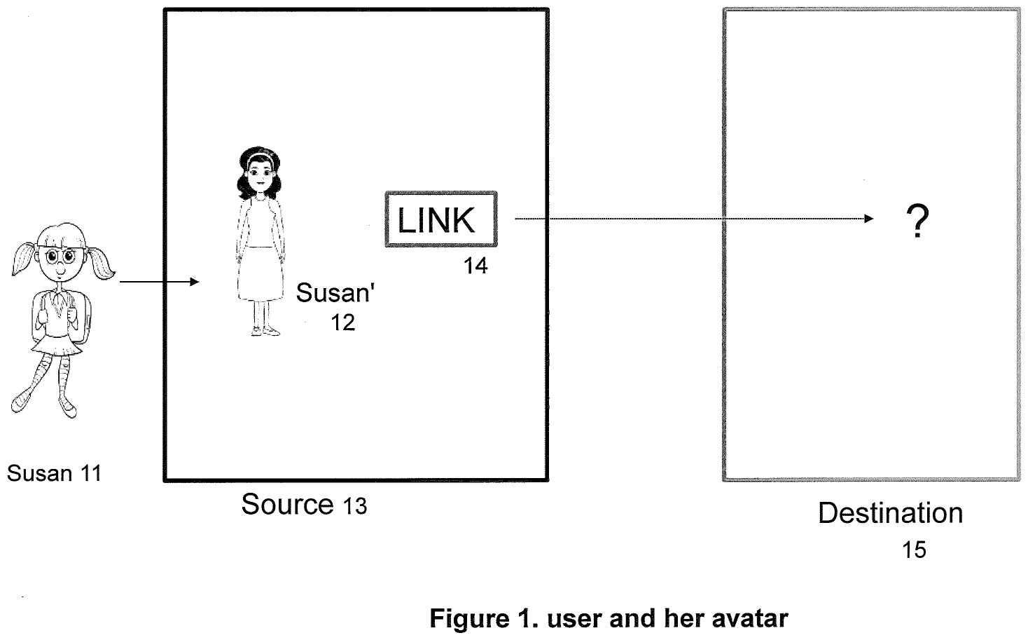

FIG. 1 shows a user Susan 11 with an avatar Susan′12 (pronounced “Susan prime”) in a VR site Source 13. Source 13 has a clickable link 14 shown in some visual form. If Susan′ clicks the link, it takes her to a destination VR site Destination 15. The link can take various visual forms. It might be a door, open or closed. It might be a button.

It might be on the outer surface of a second avatar in the room. (Not shown in FIG. 1.) The second avatar might be wearing a sandwich board on which the link is shown, or the link might be on (eg) his jacket or shirt. The second avatar walks around Source. Thus the link might be considered a “mobile link” in a new sense of the phrase. Currently, the phrase can refer to a link pointing to a cellphone or a link that is meant to be seen in a webpage on a cellphone. We use the term to mean it is worn by an avatar, which can move in a VR site. We filed a US patent pending, “Metaverse avatar wearing a clickable link”, filed 21 Mar. 2022, 17/803218.

The link itself can be represented by visible text or an image. The link can be considered to be equivalent to the HTML <a> tag. The latter has an URL as an “invisible” part. Though in practice, by moving the mouse over the visible text, the URL will be shown in the tool tip of the mouse. Or the graphical equivalent of the mouse, if the user is not using a standard browser.

The problem is depicted in FIG. 1 by the question mark in the destination site. What waits there? This is similar to the corresponding problem since the early Web. Where does an URL go to? But the Metaverse is characterized by the user wearing a 3d skin and experiencing a more “natural” immersive real life interaction with her surroundings. Unlike the Web, where she might go to a webpage of text and images. The problem is that predators might lurk at destination 15 in human (or other) form. They might accost her avatar, which can likely be interpreted as being experienced by the user Susan herself. Instances of perceived sexual harassment and virtual “rape” have been reported.

Also. Susan might be underage. Her experience then might be even more traumatic.

2] Finding Zombies;

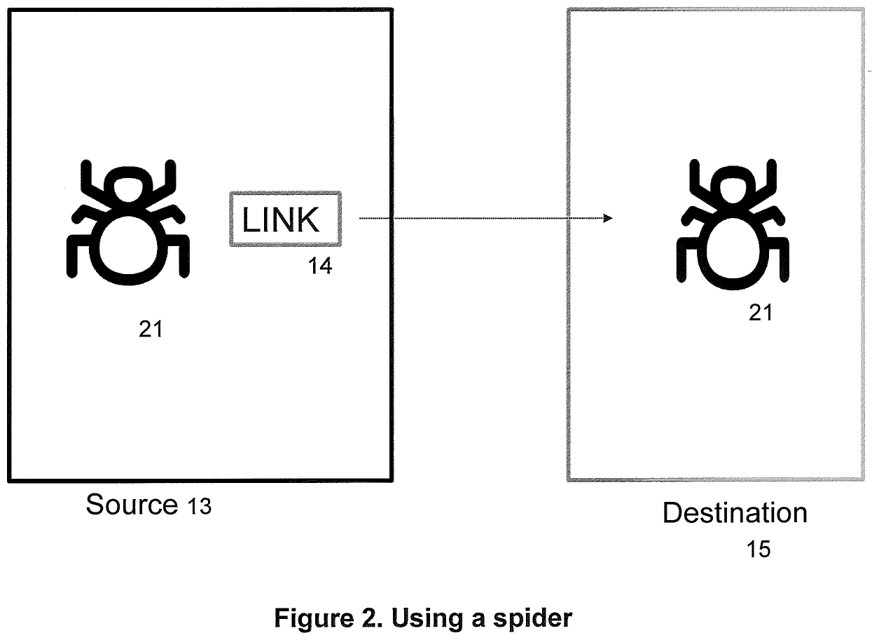

FIG. 2 shows a search engine spider 21. It starts in source 13. It goes to link 14 and thence to destination 15. It can then “crawl” room 15 looking for “bad” content. We assume the reader is well versed in knowing about search engine spiders. These are associated with the search engines GOOGLE™ and BING™ (the latter owned by MICROSOFT Corp.) But our methods here can be used by any firm, not being restricted to those 2. For example, a startup that wants to be in the search space might use these methods.

The tasks that can and should be done by the spider in the destination are different from conventional search spidering and the analysis of webpages.

One new task is to find zombie avatars in the destination. A zombie is an avatar that has been taken to the room and left there by its owner, for several hours, say. This has the effect of the zombie turning still (=inactive); being static. Ergo the label zombie. The spider can (eg) take images of the site. Then the spider leaves the site and returns in (eg) an hour. By comparing what it sees at those times, if it finds avatars that have not moved, it can infer that they might be zombies. It records the locations and likenesses of the zombies.

The spider is assumed to be run by a third party (not the source or destination sites), which we call a search engine, though very different from orthodox search engines. The engine offers a service to general users like Susan. When she clicks the link in the source room, in her likely wearing a Heads Up Display (HUD), the latter tells the search engine the destination address. The engine connects to her HUD. When she enters the destination site, she sees several avatars. The search engine marks up her view to put some visual indicator (like a “v”) above each suspected zombie. Or Susan can instruct her HUD and search engine to alter the display of the zombies by drawing them in black and white, while leaving the other avatars in full color. Other visual display methods are possible.

Susan can then ignore the zombies and focus her (networking perhaps) attention on the other (live) avatars.

A variant is when Susan is still in the Source site, when she presses link 14, the search engine returns an assessment of the Destination, to be shown in her HUD or browser. So if it has found (eg) 4 zombies, the engine might return a tally of the number of zombies in the Destination, 4. Susan might decide to skip the Destination.

Why? The zombies may be considered harmless to some readers. But Susan could subscribe to the Broken Windows model of urban decay. A neighborhood with broken windows can encourage a next higher level of vandalism and criminality. So if the Destination site has 4 zombies, perhaps the site has more serious predators loitering for visitors.

What if site Destination blocks the spider? It likely can. But the answer is to look at regular websites, which can do this. Rarely does this happen. Search is so fundamental to the Web that sites have to let spiders visit. For the current situation of FIGS. 1 and 2, if the Destination blocks the spider, its search engine will relay this to Susan when she clicks the link. She will get a warning from the search engine, saying perhaps “Warning! The site blocks spiders.” If user Susan were to regard a few spiders as suspicious, then such a warning is likely to be even more so.

We filed a US patent pending, “Ghost avatars and zombie spiders of the Metaverse”, 20 Jan. 2022, 17/803238.

3] Patrolling a VR Site;

The previous section described a search engine spider crawling a VR site to find zombies. But what about more serious offenders like drunks and sexual harassment? An answer is to leave spiders in the site. They can still search for zombies, as described earlier. But now, they surveil to find incidents like sexual harassment.

One variant is where the spider has an avatar, as perhaps required by the site. The spider avatar patrols frequently and visibly. This in and of itself can act as a deterrent to wrong doing.

The spider might be permitted by the site to crawl up walls and on ceilings. This is useful to let the spider surveil effectively. By deploying a spider camera at an elevation above most avatars, to get a good viewing position. Regular avatars would not be able to do so. It can be possible that the spider does not need permission from the site to crawl walls and ceilings.

Another variant is where the spider does not need an avatar. It is just a computer program. A ghost spider.

In either case, the site can have several spiders assigned to it. This does increase the burden on the site because it is VR. Now consider when Susan's avatar is in the Source site and looking at link 14. Susan via her browser or HUD can contact the spider server and send it the link. She asks the server for the most recent images it took at the Destination site. She wants to see who was there recently. By looking at these, and perhaps also at the zombie count found by the spider, she might decide to go to the Destination.

But suppose the spider server tells her that a spider is currently in the Destination. Another possibility is for her to ask the spider server to send the spider to her when her avatar appears in the Destination. This assumes that the spider has visible form. She tells the spider server the image of her avatar. So when she appears, the spider can quickly detect that this avatar is where it should move to. The spider acts as a quasi-guardian; as a second avatar that is now associated with Susan's avatar.

In the figures, the spider is depicted as a cartoon spider. It is up to the spider server to pick a given instantiation of the spider, and it does not have to be a spider.

This act of the spider meeting her avatar might be a means of revenue to the spider server.

Another approach is for the spider to let Susan watch thru the spider's eyes as it goes thru Destination. She likely would have to pay the server for this extra service. Here Susan need never enter the site with her avatar. Or she enters the site only after watching thru the spider first and sees that the site appears harmless. Here, Susan might be unable to control the spider's movements. Or maybe via Susan paying the server an amount, she can do so.

Instead of the spider meeting her avatar, the server can offer that a human-form avatar jump into the Destination and goes to meet her avatar. The server's avatar can come from any VR site. It is explicitly not restricted to coming from the Source site that Susan is currently at. In many cases the server's avatar can come directly from the server. The server might function in part as a staging area for a set of its avatars. This area might not be considered a Metaverse site per se, much like Susan having a staging area for her avatars. For example, a staging area might have no artificial buildings or vegetation. It is a “space” populated only by avatars owned by 1 entity (user or firm).

For reassurance and branding, this human-form avatar might wear a uniform of the spider server's firm. Perhaps with a distinctive trademark. The user might be charged a fee for this service by the spider server.

A variant is where there are 2 users, each with an avatar in Source. And each contacts the search server with the same link to Destination. The search server can offer each to share the view thru a common avatar, which can be the search spider or a human-form avatar. And the avatar then jumps to the Destination. The 2 users can watch, and communicate with each other while doing so. This is easy, via the search server letting the users have each other's address. The communication can be via text or voice or both. The address can be some type of electronic address of a user. Or simply a common chat space.

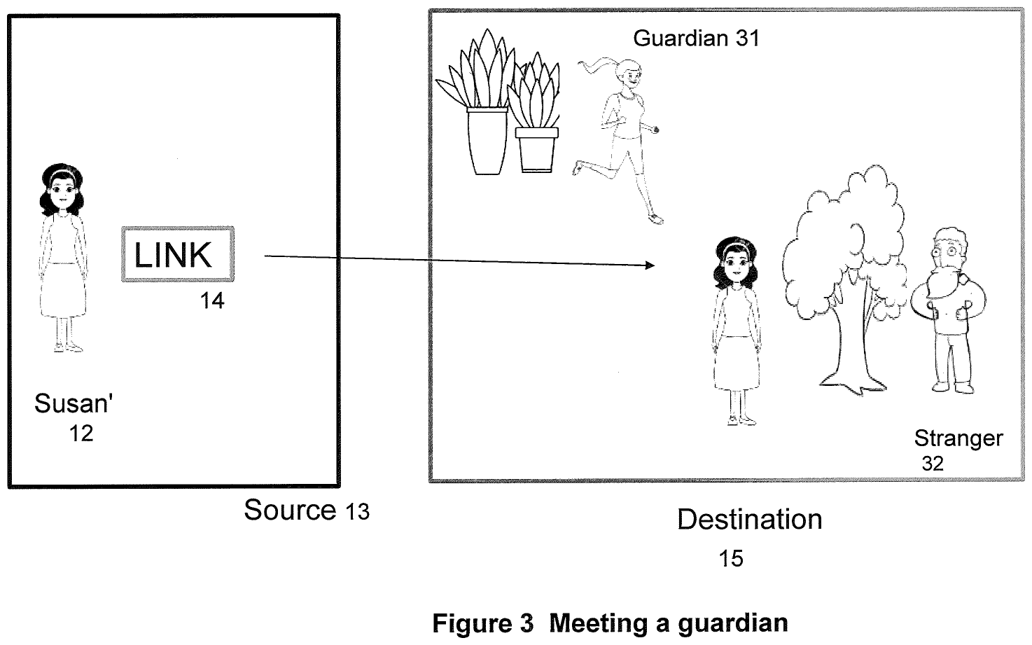

Purely as an example, the avatar might be a tall, sturdy man. To deter any predators in the Destination. FIG. 3 shows Susan′ having jumped to Destination 15. Nearby is Stranger 32. Guardian 31, in the form of a teen girl, is approaching Susan.

This example can be taken further. The spider server can offer an “enhanced” service where the humanoid avatar that greets Susan is actively controlled by a human working for the spider server. (Earlier above, the humanoid avatar was a bot.) This enhanced service would be charged to Susan at a higher price. But having a real person for Susan to chat with, and controlling an avatar near her avatar can provide good reassurance and support to her. She will no longer be alone after she jumps.

But using a human to control a human-form avatar (or any avatar) runs into a scaling limitation if many users ask for this. One response by the spider server is to turn on surge pricing, as is done by UBER CORP for real life taxi service. In the Metaverse, the cost of hiring a human would rise sufficiently to garner more revenue for the server, and to reduce the demand.

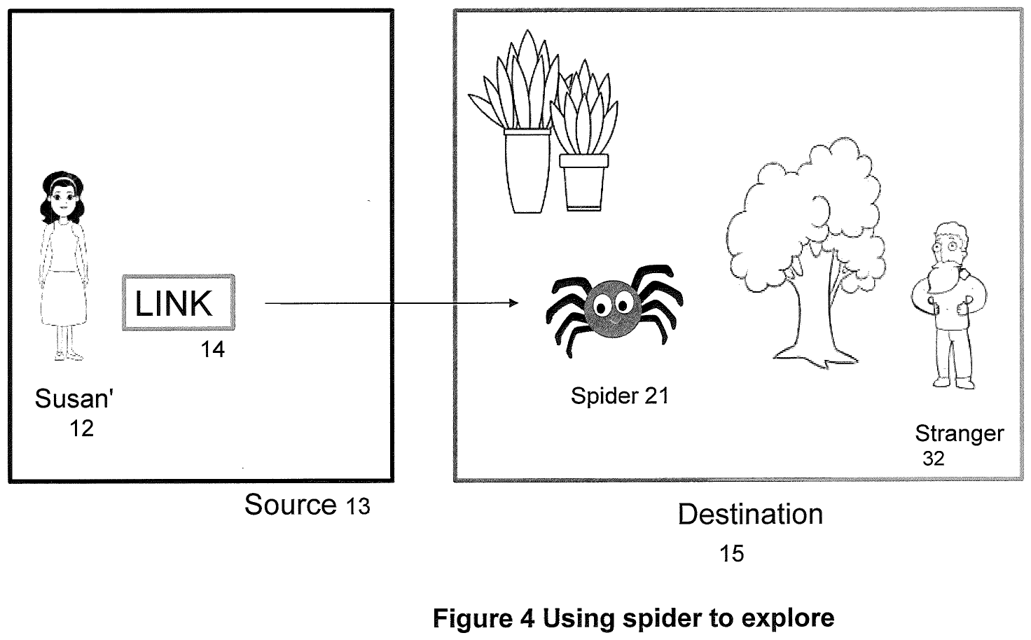

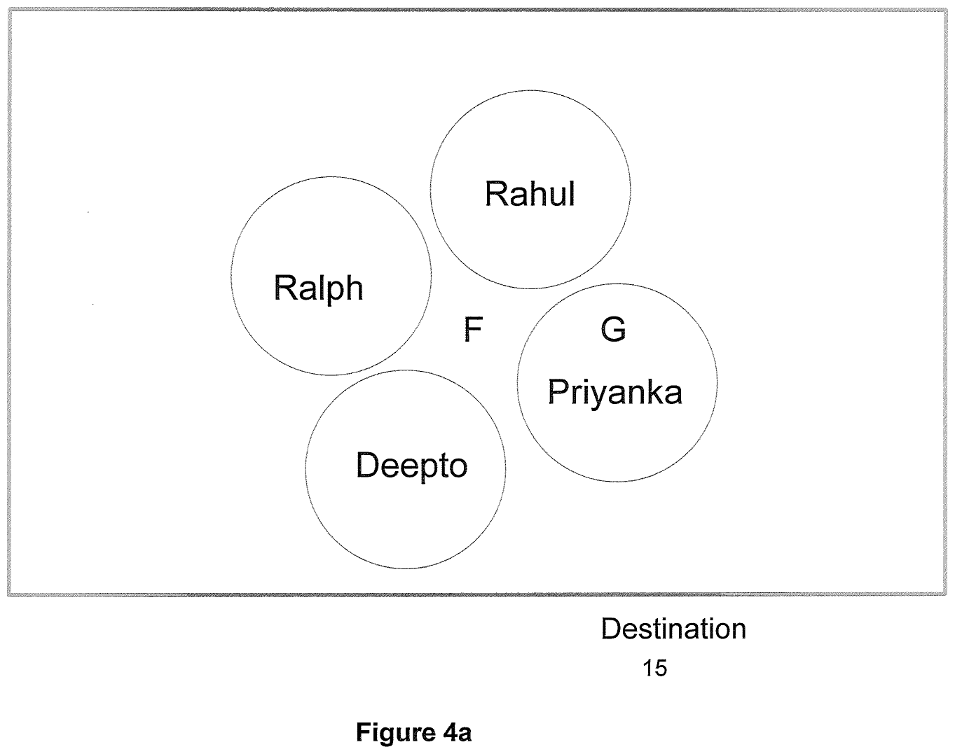

A case is possible for the spider server to let Susan see thru the eyes of a spider or of the humanoid avatar. This way, Susan's avatar can stay in the Source site, while Susan explores the Destination with another avatar. FIG. 4 shows Susan staying in the Source site, while she watches thru the eyes of spider 21 in the Destination. Control of the avatar can reside with the avatar's program or with the search engine, or with the human running the avatar. A variant is for the spider server to hand over control of the spider or humanoid to Susan, perhaps for a limited time. The server might retain a “master switch” that lets the server retake control of the spider or server avatar.

Consider the case where Susan decides to pick the link and her avatar is sent to the Destination. The site can be infinite in length and area, in principle. But the place where Susan′ appears can be quite different from where the spider appears. One possibility is that the spider first appears in 1 location and starts searching around there. How can it stop?This itself can be a property parameter. After some time, the spider stops searching, and summarises its results, which are then seen by Susan.

The next issue is what happens when Susan′ jumps to the Destination. Does she appear near the spider? This might be under the control of the site, which could deliberately put her at a distance from the spider. A mitigating factor is that the site is likely to put avatars that jump to it in some central common region, where they can interact with each other and with buildings and avatars already at the site. We assume this for now.

An extension is where there are 2 or more avatars in the Source site, and all wish to go to the same Destination site. Each person (controlling an avatar) can copy the link and send it to the search engine site. The server can cache the requests and send out only 1 or just a few spider/s to search the side. Reduces the load on the spider server and also the load on the Destination site.

The point made above is that when a user in the Source site comes across a link to the Destination site, knowing the link may leave an ambiguity about where exactly in the Destination the user will appear. The Destination site can control what happens when an avatar clicks a link to the Destination. In part, to prevent a case where several users' avatars click the same link (or copies of this link). The Destination does not want the avatars to appear at the same geometric point in the Destination. Instead, the Destination can have a policy that it sends such an avatar to some point in Destination, where the point might be “near” (in some sense) the point given in the link.

This point where the avatar appears can and indeed might need to depend on what avatars are already in the Destination. Each avatar that appears might be imbued with (eg) a protective shield around it, made as part of an anti-harassment measure. This has been suggested recently by FACEBOOK/META. The shield has the effect of fattening the avatar. So if there are many avatars appearing at Destination, the packing of the avatars can be a real issue.

FIG. 4a shows a map of part of site Destination 15. 4 avatars occupy a region. The avatars are Ralph, Rahul, Priyanka and Deepto. For each we show a cylindrical cross section of the volume occupied by it. This is a (over) simplification, but it suffices to illustrate the point. In actuality, a shield around each should take into account the geometry of the avatar's limbs more accurately. The letters F and G denote points where a link to Destination site might point, for other avatars that want to jump to the site. Point G is in Priyanka's space. In general, when the link to point G was first made, by whatever means, it could not have been known that G is off limits. Perhaps because Priyanka had not yet jumped to her location in the site. Now look at point F. It is not in any space occupied by the 4 avatars. But clearly, if an avatar tried to appear at F, its volume would impinge on that of the existing 4 avatars.

Thus a link to a destination might comprise a pointer to an entire region, like referring to a square area by giving the coordinates of a vertex and the length of a side. Clearly there are innumerable ways to do this. The destination site that gets this link when it is clicked can then pick a point in the region to put the avatar. There might also be leeway for the site to put the avatar outside the region if (eg) it cannot fit the avatar inside the region.

(More generally, the link might simply be a link to the entire area of the site, giving the site full leeway to place the avatar anywhere.)

An equivalent way is for the link to have the coordinates of a given point. The Destination can try to put the avatar there. If it cannot fit, then the Destination can have leeway to implement any alternative method to put the avatar. Where the Destination can try to put the avatar as close to the indicated point as possible.

Another effect is that when an avatar clicks a link to Destination and goes to that site, even if it tells the search engine first where it is presumably going at Destination, the spider does not know deterministically where the avatar will actually appear. The spider has to search and move, to find the avatar that communicated with the search engine earlier.

4] Checking a Mobile Link;

The mobile link of this section is a clickable link shown on the outer surface of an avatar. The avatar moves around the Source site. It tries to (eg) engage other avatars in conversation, and persuade them to pick the link it is showing.

There are at least 3 main use cases.
(a) The avatar wearing the link remains in the Source site.
(b) The avatar wearing the link also goes to the Destination after the link is clicked.

Perhaps to give a private tour.
(c) Same as (b), but as a date between the avatar with the sign and the other avatar.
(b) and (c) are where the spider server can write new factors that might be suspect. Most notably that the avatar with the link disappears afterwards. This might be considered a possible red flag in itself.

A separate factor is the reputation of the avatar. Has it been a subject of previous complaints? If so, on what grounds? Harassment?

Another factor for (b) and (c) is when Susan pauses her avatar by the other avatar and records the link. She can pass it to the search server. The latter can try to send a spider to the Destination. If the Destination successfully blocks the spider, this might be construed as extremely suspicious. And Susan is told.

Suppose the spider makes it to the Destination. It can surveil the site as done earlier. And it can act as a discreet chaperon. Recording the proceedings between Susan when she arrives, and the host. To the extent that the spider can control its visual appearance, it can attempt to blend into the color scheme of the surroundings. Or perhaps the spider can be a ghost spider, where it does not use a visible avatar.

One unknown here is whether the avatar with the link has any connection to the site that it points to. One case is where the avatar has found a portion of the Destination that is deserted, and has a link that takes the user to that area. The avatar might have no formal affiliation with the site. It can be that when Susan asks the spider server to send a spider to that location (via the link), then the suspect avatar does not know of this. If so, this aids in the spider documenting anything untoward.

We suggest it is likely that a link to a given VR site will use some type of (x, y) coordinates within the link, where x and y refer to a 2d grid of the site. While the formal syntax might currently be undefined for a given site, we propose that both coordinates will be given in the link. Thus both a user who is associated with a (eg) building location in the site, and a predator who wants to find a secluded area, can use the link with such a modification. The site will want a simple syntax, to encourage legitimate users.

5] Handling Avatar Incompatible VR Sites;

A current and serious problem in the Metaverse is that an avatar made on a VR site might not work if you try to use it on another VR site. There is no equivalent of a lingua franca like on the Web, where HTML plays this role, to make a webpage readable on all browsers. When this Metaverse problem will be solved is unclear. Each major Metaverse site wants users to make avatars on it and stay on the site. This is the walled garden approach of AOL, YAHOO (etc) on the Web in the 1990s.

We present here a simple way to accommodate the sites. Consider our user Susan. On site S, she has made a user Susan(S). On site D, Susan(S) does not work, so she made Susan(D). She wears Susan(S) on S and approaches a link in the site, that points to site D.

When she clicks the link, what is meant to happen is that Susan(S) automatically disappears from S, and Susan(S) now appears on D.

Now pressing the link does these steps:
(a) A list of her avatars appears before her, in her HUD or browser. She picks Susan(D).
(b) Susan(S) is deleted from S.
(c) Susan now wears Susan(D).
(d) Susan(D) appears in D.

The only manual step is (a). Step (a) can be improved (=automated) to remove the manual picking of Susan(D). Like, on the first (=manual) picking of Susan(D), the code that does (a)-(d) remembers this. So on a later picking of a link that goes to D, this can be done automatically. Thus the frequent use of a link that goes to the same destination can be reduced to a 1 click action, like a conventional hyperlink.

A variant is when Susan makes Susan(D), this might be on site(D) or a related site that is compatible with site(D). The act of making Susan(D) can cause a list of D-compatible sites, which includes D, to be shown and associated with this avatar. So step (a) can be replaced with a default of Susan(D) when Susan is still in site S and she picked that link going to site D. The picking of the destination site invokes a search for which of her avatars can be shown on D. If there is only 1 suitable avatar amongst her avatars, then this avatar is automatically picked. If she has 2 or more avatars that can appear on site D, then she might have to manually pick one.

When we write Susan(S), instead of a specific site S, it can be a set of sites, run by independent firms or not, that let avatar Susan(S) be displayed and run in them. Over time, as more sites become compatible, avatars can be removed from Susan's list, which reduces the maintenance cognitive load on her. Because we don't know the schedule for this, the current method can suffice in the interim.

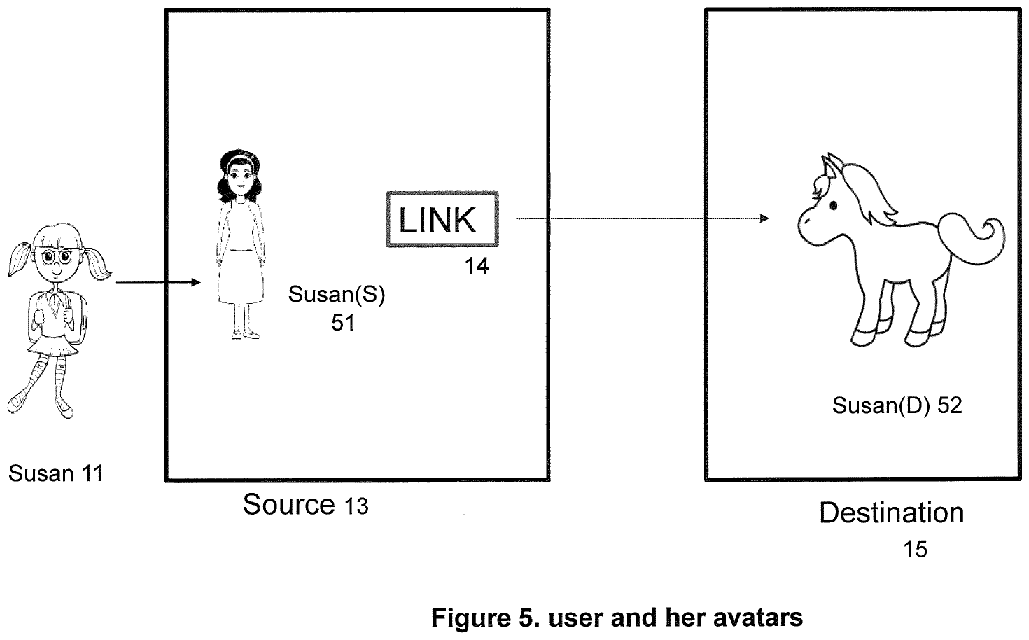

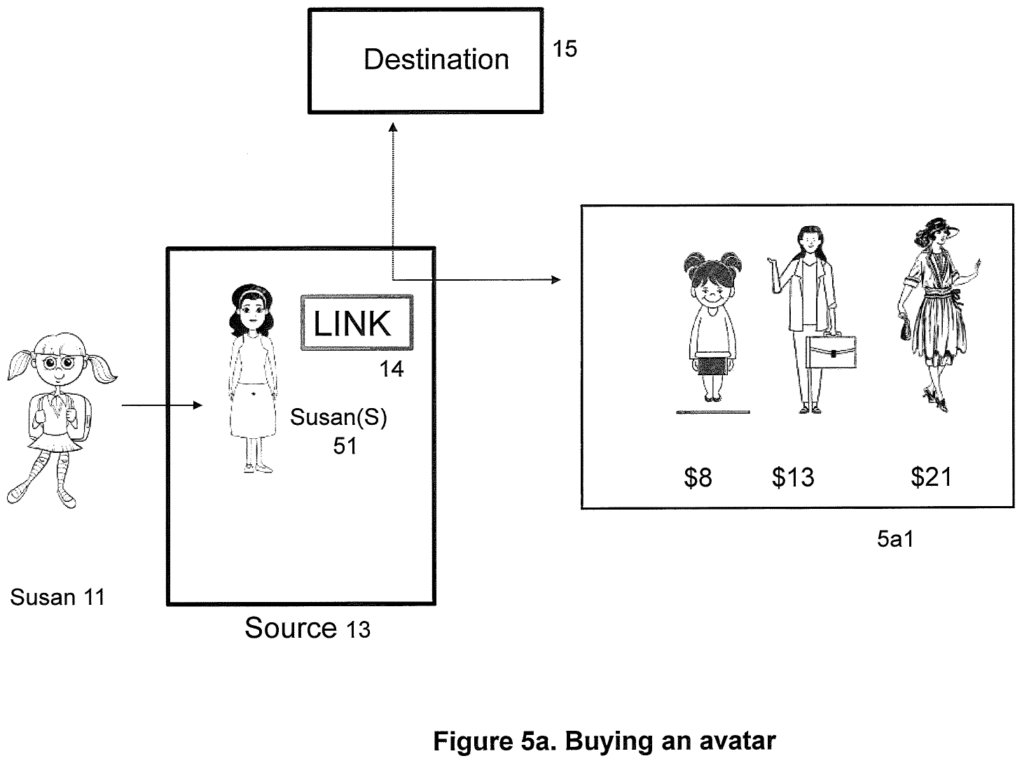

Susan can choose her avatars any which way she wants. Specifically, these avatars do not need to look like each other. Susan(S) might be female. Susan(D) might be male. They might be of different human races or ethnicities. Or of different species. FIG. 5 shows Susan having 2 avatars. 1 is Susan(S) 51 for the source site. Another is Susan(D) 52, which is a horse.

Related to this is the following. Suppose Susan has Susan(S) but not Susan(D). When Susan using Susan(S) goes to the link in site S to site D, and picks the link, a menu can be shown of D-compatible avatars. These can be made by third party vendors Alpha, Beta, . . . . Each vendor might list 1 or more avatars. All of which can be used by Susan. The avatars are available at different prices (or perhaps all at the same price). This helps foster commerce and the increased interoperability on the Metaverse. FIG. 5a shows Susan having a choice of 4 avatars (shown in item 5a1) for site D. An can be shown in Destination 15.

Possible reasons for incompatibility between sites include: one site only needs low resolution avatars, while another site needs higher resolution; one site must have avatars in a cartoon style while other sites don't care; one site needs avatars showing youngsters (eg <10 years), while other sites don't care; one site needs avatars in human form, while others don't care.

If Susan is young (under some age limit) then the making for an avatar for her might be restricted to (eg) picking amongst some set of defined avatars. Where she might be able to personalize her choice in some simple ways. For example, she can change the hair length (long, medium, short) or color (red, green, blue) or style (crew cut, Mohawk, ponytail). Or she might be able to pick a time period and get an avatar preset for that period (1800, 1900, 1920 flapper, 1980 punk). Some templates can be made available for all ages of users.

A consequence of a user having avatars that look different follows from the previous section. When Susan goes to the link in the Source site, and asks the spider server to have a spider or human-form avatar greet her at the Destination site. Now she sends the server a photo of her horse avatar that would be used in the Destination, instead of the photo of her human avatar in the Source site. This tells the spider server what avatar to look for.

6] Transporting an Item Between VR Sites;

Consider Susan starting in site S(ource). She is carrying or pushing an item she found in S. The item might be a stick or flag or cart, for example. She goes to link 14, Suppose for simplicity her avatar Susan in site S also functions in site Destination. Here, we use Susan to refer to both the user and her avatar. She presses link 14. The link software can see that in 1 or both hands, she has an item that is not part of her avatar. The item is defined by some 3d map. When the link causes her avatar to be shown in Destination, it can also cause the item in her hands to be removed from site S and to appear in Destination, next to her avatar.

Whether or not her precise spatial relationship to the item is maintained after the traversal can depend on the item. If she is using 1 or both hands to hold it, this “posture” can/should be kept in the new site.

But just as there can be incompatibilities between sites for an avatar, so too for an item carried or pushed by the avatar. If the new site cannot handle the item for whatever reason, then it can be abandoned in the earlier site. This can be done automatically or Susan might be presented with a choice (leave item in site S/stay in site S) when she presses the link.

Another issue is that suppose Susan has a different avatar in Destination, and it is not able to hold or carry or push the item. Then the item might be left in the earlier site. Or it can appear in the new site. But now she cannot move or control it. This also argues in favor of a user choosing an avatar that is humanoid. It has arms and legs (a tetrapod), which let it mimic a person.

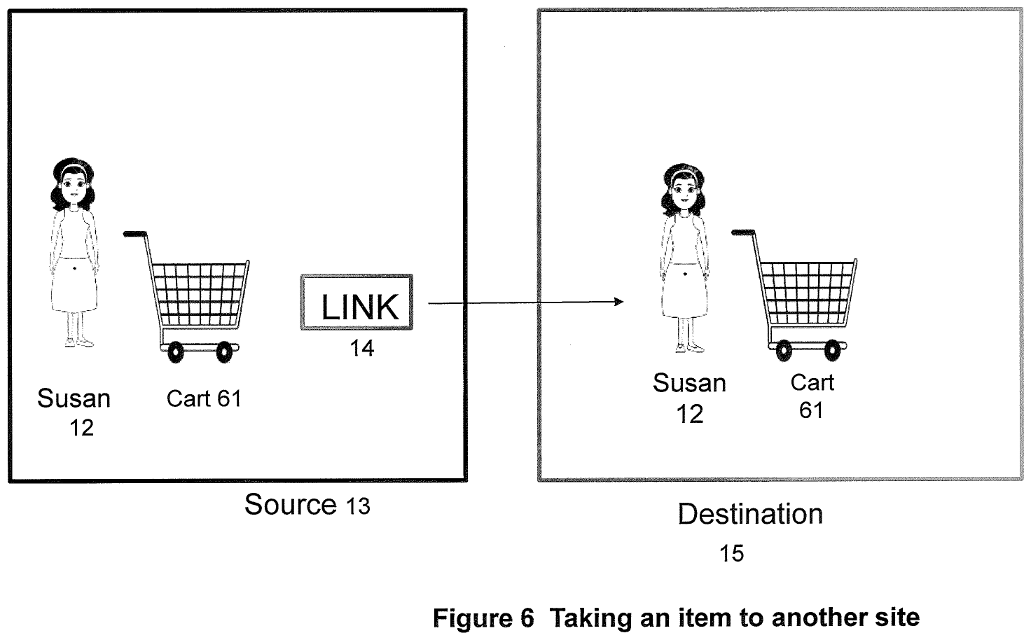

FIG. 6 shows Susan taking cart 61 from site S to site Destination.

Note that the concept of carrying items to another site is addressed in gaming for items like coins, potions, scrolls, food, weapons by having them be just text items in a list. And the list is carried by the game character. Typically, the list has no volume. For example, scrolls or potions are not carried in 3d form (usually). Ditto for food or coins. Weapons might be treated by having a finite limit on how many can be carried. But typically if a user's avatar carried several weapons, only 1 is shown at a time. The treating of a game character's weapons as merely items in a list is perhaps a holdover from text-based games of the 1980s like Rogue; these were not games in VR.

This might still be done here. But this section is more concerned with dealing with items that are represented with a finite and non-trivial 3d span in VR.

By being able to move items across VR sites, it increases chances for more interactions including ecommerce between avatars and perhaps more realism. Though granted the latter might not be desired on some sites. The transporting of virtual items can help create a market for them, where the items are paid for in some virtual currency or in fiat money.

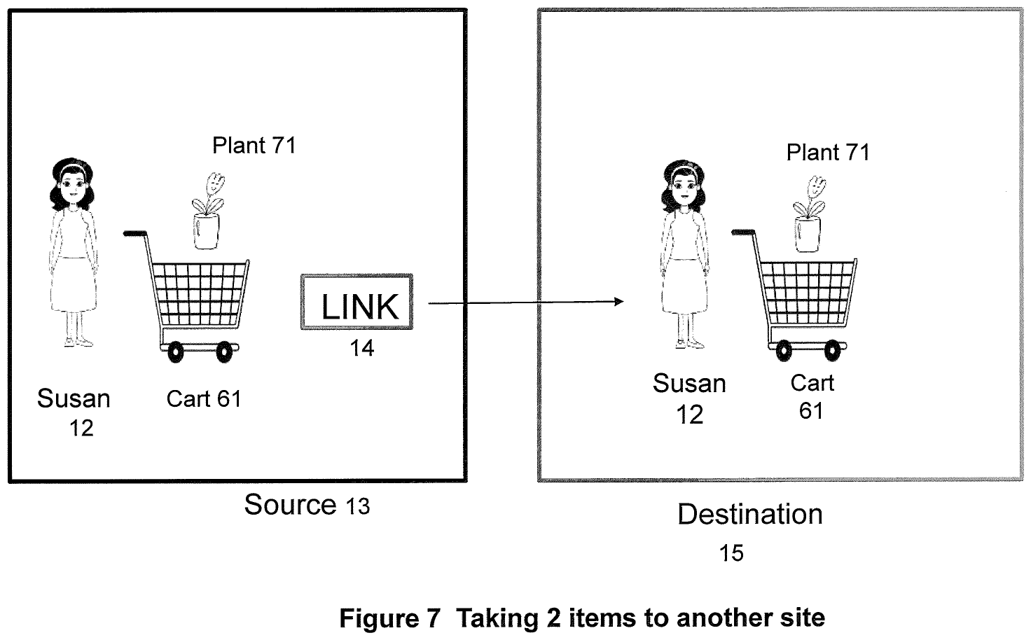

FIG. 6 begs the question. The item is a cart, which can carry things. So if the cart carries, say, a potted plant, Susan can also carry this to site Destination, as in FIG. 7. The cart carried potted plant 71 to site Destination. This can be extended to her carrying several items.

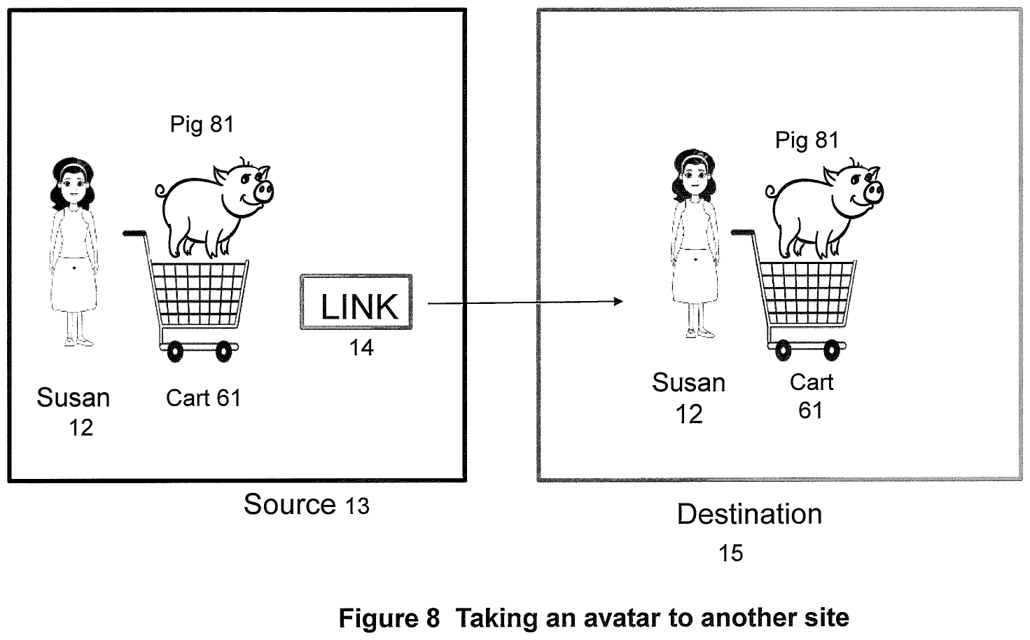

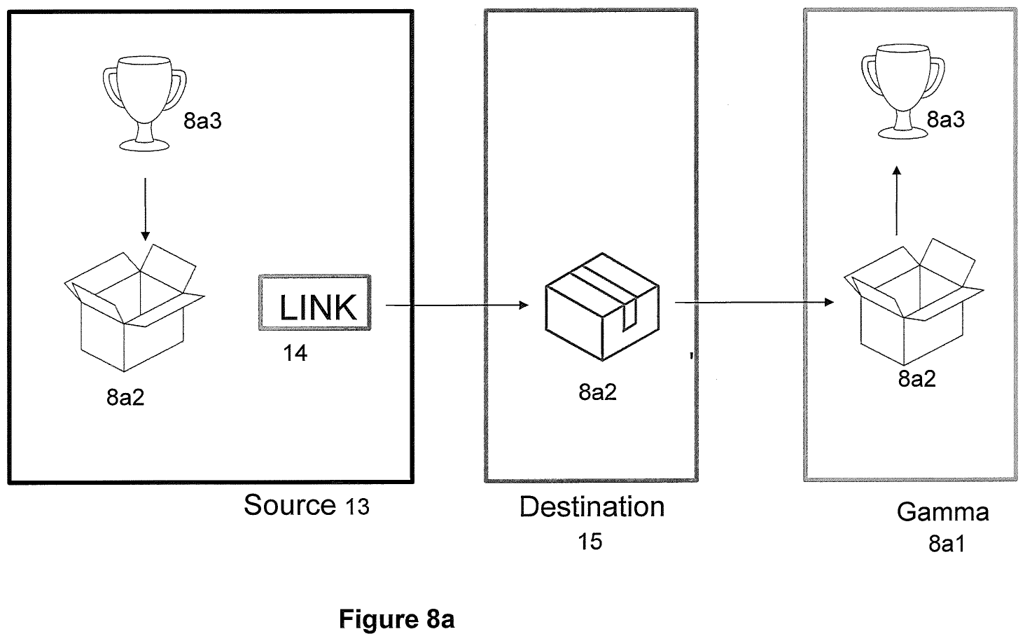

FIG. 8 shows where now the cart carries pig 81 to site Destination. Here, pig 81 is an avatar, controlled by another human. This figure assumes that the avatar pig can be shown in both sites without problems. Here, Susan makes the decision to take both of them from site S to site Destination. When the pig goes thru, the person controlling the pig now sees that the site of his avatar has changed, thru no action of his own.

One complication is if the pig is not compatible with the site Destination. Here, when the link is picked, the link software needs to ask the owner of the pig to choose an avatar that he owns, that can be shown on Destination. If no such avatar exists, then the link can fail, and both Susan and the pig are stuck in site S. Or just Susan's avatar goes thru, pushing an empty cart.

Suppose the pig avatar can be shown in site S, but on site Destination it cannot. However, the owner of the pig had days previously made an avatar Horse for site Destination. Then when the pig is transported over to Destination, it is automatically changed to avatar Horse. Thus the owner of pig finds that pig has been changed to Horse thru no current action on his part.

FIG. 8a shows a box 8a2 in site Source 13. A trophy 8a3 is put into the box and the box is closed. The avatar Susan is implicit in the figure. She takes the box via the jump link to Destination 15. In this site, the trophy cannot be rendered. If the box is not opened, the Destination site might decide to “leave” the trophy in the box. This is like in quantum mechanics, where the trophy is an un-observable in the site.

Susan then takes the box to site Gamma 8a1. In this site, the trophy can be rendered. So if Susan opens the box, she can take out the trophy.

An edge case is where the trophy is put in the box, and the box has a transparent window, thru which Susan and others can see the trophy in site Destination, perhaps. It can be up to the site Destination to decide whether the trophy can indeed be seen in the box in site Destination. The site can have (eg) an altered image of the trophy, which the site shows in the box window. The image can be (eg) a low resolution image of the trophy. Where Susan might have to take the box to site Gamma to get the trophy out of the box and see it in high resolution.

The complication of FIG. 8a can clearly be extended in an obvious manner to cases where a container has items that cannot be shown on a site but the container is not opened.

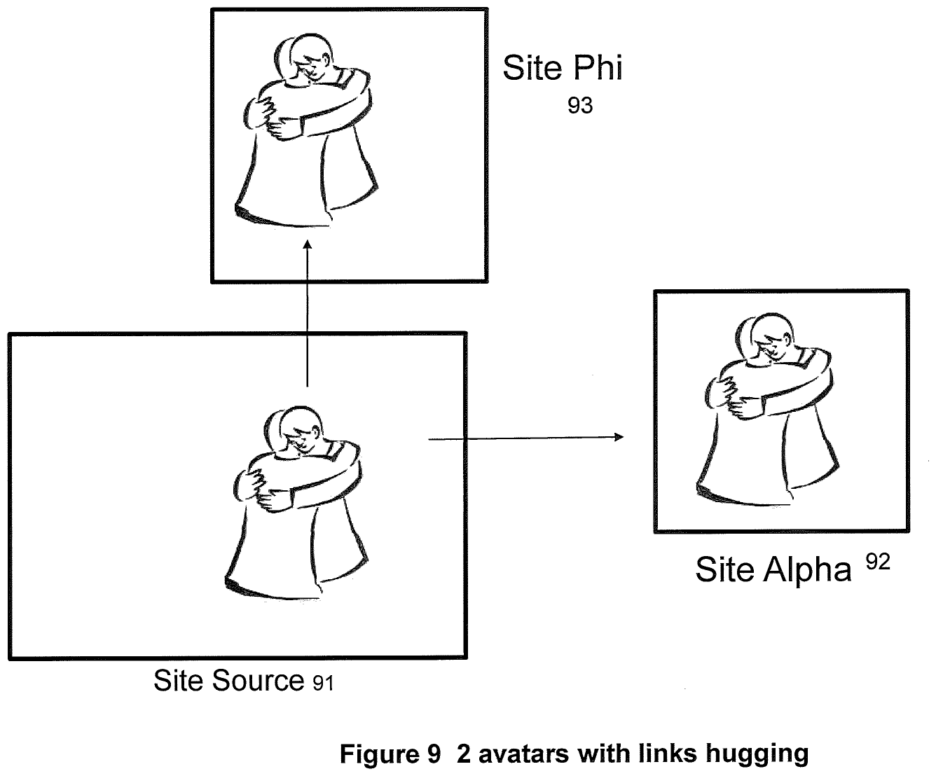

FIG. 6 and the above discussion about an avatar and items she is carrying or pushing being able to go to another VR site also suggests the following. In FIG. 9, in VR site 91, an avatar wearing a clickable link can cause a nearby avatar who touches the link to go to that destination. Suppose this is true for an avatar in FIG. 9. It has a clickable link that sends the other avatar to destination Alpha 92. And suppose there is another avatar who also wears a clickable link, that sends a nearby avatar who touches it to destination Phi 93. Then imagine both avatars hugging, as in FIG. 9. Who sends who where?

One answer is that the first avatar to have its worn link be triggered by the hug will cause that link to be activated, and thence send both avatars to that destination. This “first” is determined by the computer program running that implements the site 91. There is an element of uncertainty. A multi-threaded processor running the site might load a thread for 1 avatar, and another thread might be for the other avatar. The former thread might start first. But the latter thread might then be run, albeit starting second, and execute its link first. Because the computational load on each thread can vary, letting the second thread finish first in some instances. I

The ability of an avatar to carry or push virtual items to another site offers a different means of protecting the avatar when she jumps to that site.

First. The cart she pushes can contain a weapon that works on the destination site, like a club.

Second. The cart has a bot (robot animation) like a dog or wolf, which can protect her.

Third. She can carry a second avatar. The latter functions as a bodyguard in the destination. So if (eg) she does not want to wait for a guardian avatar to meet her in the destination, but a guardian present in the current site Source, she can use it instead and take it with her. (Assuming that the search engine approves her use of its avatar.)

7] Transmitting a Spoken Site Address by an Avatar;

An avatar can transmit the address of a destination site to another nearby avatar, by speaking the address. The speaking can be done by an avatar Tim 1003 vocalising each symbol (letter, digit, character) in the address. A nearby avatar can listen to it, and transcribe the sounds into text that is the address. The vocalizing by 1 avatar can be easily automated by a first program, item TTS (Text To Speech) 1005. The transcribing by another avatar Ann 1002 can also be easily done by a different program ASR (Automatic Speech Recognition 1004). Once avatar Ann has done this, the link can be shown by the program on the display of Ann's operator. The only manual action is by the human, who makes a decision (presumably) to pick the link, whereupon Ann is transported to the link site.

This goes beyond the common if not universal treatment of avatars currently done, where an avatar is regarded merely as a skin of polygons with perhaps articulation defining mechanical functionality. Now an avatar can invoke an API (Application Program Interface) to access computational resources like a TTS (Text To Speech) and an ASR (Automatic Speech Recognizer). The latter modules can be physically located on the server handling the site. TTS 1005 is shown inside site 1001 to suggest this. Or a module might be on a computer separate from the site, like ASR 1004.

One can suppose that a module in the avatar might have a network address that first refers to a module in the site server. But if the site does not have that, it can delegate to an external module.

A variant is that the vocalizing can be sped up; to be said faster than can be done by a human. And the corresponding ASR can also be sped up. By not having a human in the loop, this improves performance.

The method of this section reduces the cognitive load on the users who say the link (Tim's operator) and who see the link (Ann's operator). In doing so, it reduces the errors. If Tim's operator had to say the link himself, he might omit or repeat a letter. And a link might be 100% correct, so it is brittle. And Ann's operator might mishear a vocalized letter. Now, each operator essentially presses a button (metaphorically or literally), and the operation is carried out by a machine.

It also means that a link or parts of it might be vocalized as words (if the link has these) if possible.

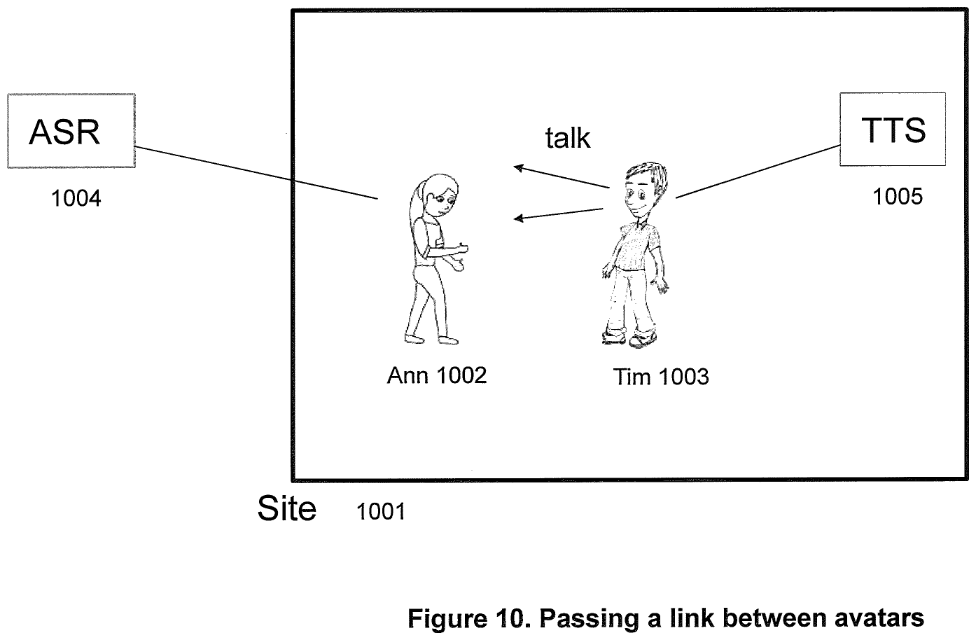

Methods here can be generalized to other types of communication. Return to FIG. 10. Tim moves closer to Ann. He holds her arm using his arm. He taps out Morse code with his fingers on her arm. This is low bandwidth and Tim's user might not know Morse code. But he can invoke a subroutine for Morse code. And Ann can run a complementary subroutine to decode what Tim is tapping. Neither user needs to know Morse code. The assumption is that both users can find the appropriate mapping.

Or Tim might blink rapidly at Ann in Morse code. She decodes it. Neither user needs to know Morse code.

8] Different Places in a Destination Site;

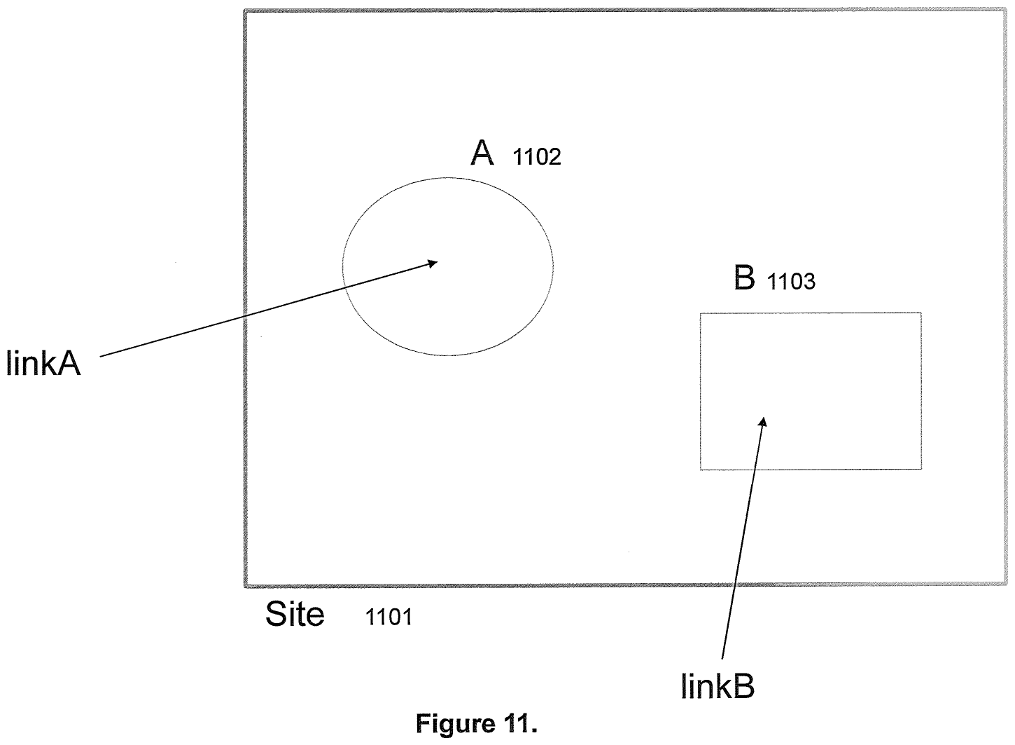

FIG. 11 shows 2 links to different destinations in the same destination site 1101. LinkA points to a location in region A 1102. LinkB points to a location in region B 1103. Imagine that region A has been surveyed/patrolled by spiders and is considered reputable and safe. While region B might have been assessed by the spiders as a sketchy part of the site. Or, perhaps spiders have not or rarely gone to region B. So there might not be any negative assessment of region B.

And a user starting in region A might have to walk a considerable distance to reach region B. Or there might be obstacles in the way.

When a user gets a link to the site, and she has the search engine assess it—if the engine finds that the link goes to region A, it might leave the link unchanged and the user can jump to region A. But if the link goes to region B, the engine might alter the link, so that it goes to some location in region A. This decision can be a function of:
a] The age or sex of the user. If the user is 8 years old, the engine might definitely alter the link so that it points to region A and not to region B.
b] The history of the user's experiences, on this site or other sites. If the user had negative experiences in the past, then she might ask the search engine to be conservative, and send her to only a “good” part of the site.

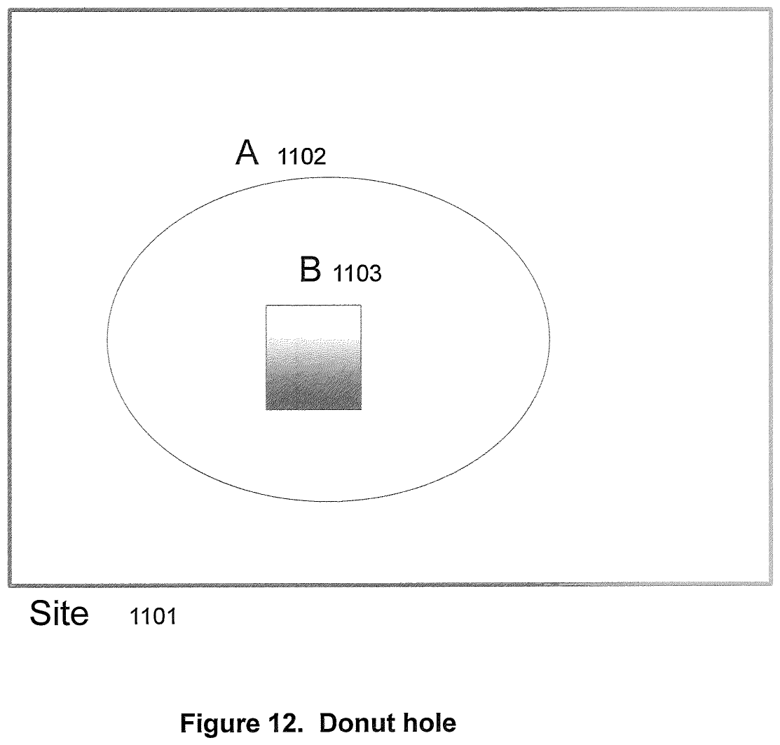

FIG. 12 shows a “donut hole” that is region B 1103. It is surrounded by region A 1102. Suppose region A has been spidered and it is considered a safe area. But region B has rarely been spidered. Perhaps users rarely go to region B. If regions A and B are “outside”, there might be trees, bushes etc, that form a perimeter of region B, and make it relatively inaccessible to users who are in region A. Or if region B is inside a building, there might be walls and furniture that act to block region B from region A.

A predator might lurk in region B. And its user might craft a linkB that points to the inside of region B. The point is that a “good” region A can still contain subregions that are rarely used, in which a predator can lure unsuspecting visitors. This assumes that a predator can craft links to fairly precise locations in a site, if he knows the format of the link. The latter is a reasonable assumption for many sites.

Note also that what we call a link to (eg) region A (eg. LinkA) or a link to region B (eg linkB) does not have to refer to a specific point in those regions. Instead, the link addressing scheme of the site might point to an entire region or area in the site. Where if a user outside the site clicks the link, this causes a reference to that area, and the linking firmware picks a point inside the area. The choice of a specific point in the area can be random or not.

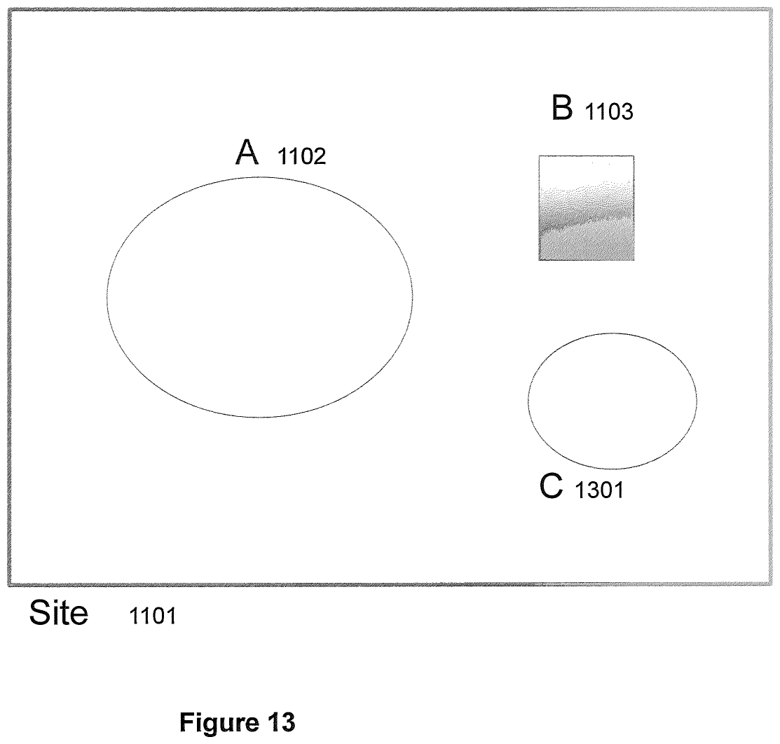

FIG. 13 shows 3 regions in destination site 1101. Region C 1301 might be a playground area for avatars depicting children under 10 years old. Outside the destination, there might be links going to within region C. These links would be suitable for children using those child avatars, or even adults using those avatars. It also means that if a user presses a link that points to region A or region B, and the link is then sent to (eg) the search engine to analyze, then the following can be done. The search engine might have data on the user indicating that the user is a child. And the engine finds that region A might be unsuitable for the child. The engine can replace the link with a link to region C. And this link is then executed to jump the child user to region C.

Conversely, suppose the engine gets a link to region C, sent to it by a user in another site. The engine knows from prior data that the user is an adult. If region C has a strict policy that users in it should be kids, (with only a few exceptions like parents), then the engine can replace the link with a link to regions A or B.

The previous 2 paragraphs described a search engine being able to modify a link to be more suitable to the user, based on 1 or more of the user's identity or the user's avatar's identity. This modifying might also instead be able to be done by the destination site. The latter can alter the link from 1 location in the site to another location, based on data about the user or the user's avatar, and based on the expected use of each site.

9] Use of a “Search Engine” and Spider;

Many times above, we referred to a search engine and its spider. This is largely to describe the tasks done in this invention as being analogous to tasks done by a conventional search engine. We did this to aid the reader understanding the new ideas of the invention. So we found the closest existing programs (search engine+spider) and argued for a possible extension of their duties.

This is not strictly necessary. The reader can appreciate that the tasks in this invention are different enough from conventional search engines that the entire description in terms of search engines need not have been used. The “spider” could have been described as a special type of avatar, with no need for a spider-type representation. And the “search engine server” that ran the spider could have just been called (eg) a “guardian server”.

We claim:

1: A method of a first user with a first avatar in a first Virtual Reality (VR) site finding information about a second VR site;
the first avatar being near a link in the first site that goes to the second site;
sending, by the first user, the link to a search engine;
receiving, by the first user, images from the search engine of the second site;
the images taken by a spider run by the search engine;
receiving, by the first user, a count of inactive avatars at the second site from the search engine.

2: The method of claim 1, where
the first avatar uses the link to visit the second site.

3: The method of claim 1, where the spider climbs a wall or ceiling in the second site, to surveil the second site.

4: The method of claim 1, where the search engine has a spider in the second site;
asking, by the first user, the search engine to send the spider to meet the first user when the first user uses the link to go to the second site;
the first user sending a photo of the first avatar to the search engine;
the first avatar using the link to go to the second site;
the spider recognizing the first avatar;
the spider going to the first avatar;
the spider walks with the first avatar thru the second site.

5: The method of claim 4, where:
the first user controls the movement of the spider in the second site.

6: the method of claim 1, where the first user asks the search engine to send a humanoid avatar to the second site;
the first user sending a photo of the first avatar to the search engine;
the first avatar meeting the humanoid avatar in the second site;
the first avatar and humanoid avatar walking thru the second site.

7: The method of claim 6, where the humanoid avatar is actively controlled by a human working for the search engine;
the human being different from the first user.

8: The method of claim 7, where the search engine charges the first user a fee for the service.

9: The method of claim 4,
where there is a second user with a second avatar in the first site;
where the second avatar is near a link in the first site to the second site;
where the first user and the second user watch images seen by the spider as the spider moves in the second site.

10: The method of claim 9, where the second avatar does not go to the second site.

11: The method of claim 9, where the second avatar goes to the second site.

12: A system of handling avatar incompatibility on VR sites;
a user having 2 different avatars, avatar-A and avatar-B;
avatar-A can be shown on site A;
avatar-B can be shown on site B;
avatar-A cannot be shown on site B;
avatar-B cannot be shown on site A;
the user uses avatar-A in site A;
the user approaches a link to site B;
the user presses the link;
avatar-A is deleted from site A;
the user wears avatar-B;
avatar-B appears in site B.

13: The system of claim 12, where:
the user is in site A and is near the link;
the user asks a search engine to have a spider meet the user in site B;
the user sends the search engine a photo of avatar-B;
the user presses the link;
the user appears in site B wearing avatar-B;
the spider approaches avatar-B;
the spider recognizes avatar-B;
avatar B meets the spider;
avatar B and the spider walk thru site B.

14: A method of a user trying to transport a virtual item between two virtual sites;
the user wearing a first avatar in a first site;
the first avatar pushing or carrying a first item;
the first avatar approaching a link in the first site;
the link pointing to a second site;
the first avatar pressing the link;
the first item being able to be shown in the second site;
the first avatar and the first item appearing in the second site.

15: The method of claim 14, where:
the first item cannot be shown in the second site;
the first item is left in the first site;
the first avatar appearing in the second site.

16: The method of claim 14, where:
the first item holds a second item;
the second item being able to be shown on the second site;
the first avatar, the first item and the second item all appearing in the second site.

17: The method of claim 14, where:
the first item holds a second item;
the second item not being able to be shown on the second site;
the first avatar and the first item appear in the second site;
the second item being left on the first site.

18: The method of claim 14, where:
in the first site, the first avatar carries a second avatar;
the second avatar being worn by a second user;
the first avatar clicking the link;
the second avatar being able to be shown in the second site;
the first avatar and the second avatar appear in the second site.

19: The method of claim 14, where:
the first item encloses a second item;
the second item cannot be shown on the second site;
the first avatar and the first item appear in the second site;
the second site has a link to a third site;
the second item being able to be shown in the third site;
the first avatar pressing the link to the third site;
the first avatar and the first item appear on the third site;
the first avatar taking out the second item from the enclosing first item.
